(19) United States
(12) Patent Application Publication
(10) Pub. No.: US 2022/0400070 A1
(43) Pub. Date: Dec. 15, 2022

(54) SMART SAMPLING AND REPORTING OF STATEFUL FLOW ATTRIBUTES USING PORT MASK BASED SCANNER

(71) Applicant: VMware, Inc., Palo Alto, CA (US)

(72) Inventors: Jayant Jain, Cupertino, CA (US); Rick Lund, Livermore, CA (US); Russell Lu, Pleasanton, CA (US); Sushruth Gopal, Sunnyvale, CA (US); Subrahmanyam Manuguri, San Jose, CA (US)

(21) Appl. No.: 17/347,706

(22) Filed: Jun. 15, 2021

(51) Int. Cl. H04L 12/26

(52) U.S. Cl. CPC H04L 43/0876; H04L 43/062

(57) ABSTRACT

The method of some embodiments samples data flows. The method samples a first set of flows during a first time interval using a first logical port window for the first time interval. The first logical port window identifies a first set of non-contiguous layer 4 (L4) values in an L4 port range that are candidate values for sampling the flows during the first time interval. The method also samples a second set of flows during a second time interval using a second logical port window for the second time interval. The second logical port window identifies a second set of non-contiguous L4 values in an L4 port range that are candidate values for sampling the flows during the second time interval.

Flow reporting is the determination and tracking of which applications are producing flows of data packets sent through or received on ports associated with an IP address (e.g., layer 4 (L4) ports associated with an IP address at a datacenter). In recent years, flow reporting has become extremely important in the network security domain and has sprouted the security information and event management (SIEM) market segment for analytics which completely relies on logs as well as various flow reporting techniques such as Internet Protocol Flow Information Export (IPFIX).

As network utilization goes up, the number of flows to analyze and report on poses an increasing computer and network processing challenge. Typical techniques used today are random sampling of flows of ports (which may omit some ports and scan others multiple times in a given period) and aggregation. As the requirements to report more attributes related to all the flows on a workload come in, such as layer 7 (L7) parameters like application ID (APPID), Cipher Suites, uniform resource locators (URLs), domain name system (DNS) Queries etc., the capacity of port scanners to work in conjunction with enforcement and reporting criteria for both simple transport layer (L4) of flows and application layer (L7) of flows, becomes very hard to manage and balance without affecting the basic guaranteed functionality of the scanners, especially for L7 enforcement due to the limited resources available. Typically a hypervisor is able to monitor 50K L4 flows and 15K L7 flows. It is not practically possible to discover and report L7 attributes for L4 flows using the same resource as what is being used for enforcement of L7 flows, given that only 15K L7 flows (out of 50K L4 flows) can be discovered. Therefore, a better way is needed to systematically scan ports, associated with an IP address, to identify L7 attributes of data flows.

### BRIEF SUMMARY

Some embodiments provide a mechanism to report stateful flows which scans the port ranges of incoming and/or outgoing packets so as to effectively cover the full sample range hence, providing a fine balance between sampling and aggregation while providing a complete picture of the flows sent to or from an IP address.

Some embodiments provide a method of sampling data flows. The method samples a first set of flows during a first time interval using a first logical port window for the first time interval. The first logical port window identifies a first set of non-contiguous layer 4 (L4) values in an L4 port range that are candidate values for sampling the flows during the first time interval. A set of L4 values are non-contiguous when the set includes several values in a sequence including a first value, a last value and several intermediate values in between, with at least some of the successive values in the set (e.g., two intermediate values that follow each other in the sequence of values in the set) not being consecutive values in any numerical range.

The method also samples a second set of flows during a second time interval using a second logical port window for the second time interval. The second logical port window identifies a second set of non-contiguous L4 values in an L4 port range that are candidate values for sampling the flows during the second time interval. The L4 values may be source port values and/or destination port values in some embodiments.

The first set of flows is limited to a threshold number of flows, in some embodiments. The method may determine that the first set of flows has fewer flows than the threshold number and, based on that identification, provide a new threshold number of flows for the second set of flows, wherein the new threshold number of flows is greater than the threshold number of flows for the first set of flows.

The method of some embodiments further determines that a particular flow to a port in the first logical port window has previously been inspected. Based on that determination, the method excludes the particular flow from the first set of flows. Determining that the particular flow has not previously been inspected may include checking a source port of a packet of the particular flow against a set of records of source ports of previously inspected packet flows. Alternately, determining that the particular flow has not previously been inspected may include checking the destination port and destination IP address of a packet of the particular flow against a set of records of destination ports and destination IP addresses of previously inspected packet flows.

Sampling a flow may include copying one or more packets in the flow for analysis, extracting information from these packets or extracting information by analyzing these packets. This extraction and/or analysis in some embodiments involves examination of an application layer (e.g., L7 layer) of packets of the flow. In some embodiments, the sample flows are first copied and then the copies are examined to extract information about the flows.

As mentioned above, a sampled logical port window in some embodiments is a set of non-contiguous L4 values that includes several values in a sequence including a first value, a last value and several intermediate values in between, with at least some of the successive intermediate values (i.e., intermediate values that follow each other in the sequence of values in the set) not being consecutive values in any numerical range. However, in some embodiments, one or more logical L4 windows (i.e., one or more sets of non-contiguous L4 values) include contiguous buckets of values but two or more buckets of such values are not contiguous with respect to each other. For instance, a first logical window (i.e., a first set of non-contiguous L4 values) may include at least two consecutive port values that are part of one contiguous bucket of values that is followed by value that is not the next port number in a numerical range after the last port number in the bucket. However, in other embodiments, no logical window (i.e., no set of non-contiguous L4 values) includes any consecutive port values.

Each L4 value, in some embodiments, is defined by a binary number including two sets of binary digits, where each L4 value in the first logical port window has the same set of values for one of the sets of binary digits. The binary number, in some embodiments, has sixteen binary digits and the final four binary digits of the binary number have the same value within a particular logical port window.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates a flow sampling system 100 of some embodiments.

FIG. 2 conceptually illustrates an example of prior art port window sampling ranges.

FIG. 3 conceptually illustrates an example of logical port windows with non-contiguous port values, used to identify candidates for flow sampling.

FIG. 4 illustrates examples of logical port windows with no contiguous port values.

FIG. 5 conceptually illustrates a process for sampling packets using a logical port window.

FIG. 6 illustrates a host computer implementing a flow sampler that samples packet flows using non-contiguous logical port windows.

FIG. 7 illustrates a datacenter with a port scanner of some embodiments.

FIG. 8 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method of sampling data flows. The method samples a first set of flows during a first time interval using a first logical port window for the first time interval. The first logical port window identifies a first set of non-contiguous layer 4 (L4) values in an L4 port range that are candidate values for sampling the flows during the first time interval. A set of L4 values are non-contiguous when the set includes several values in a sequence including a first value, a last value and several intermediate values in between, with at least some of the successive values in the set (e.g., two intermediate values that follow each other in the sequence of values in the set) not being consecutive values in any numerical range.

The method also samples a second set of flows during a second time interval using a second logical port window for the second time interval. The second logical port window identifies a second set of non-contiguous L4 values in an L4 port range that are candidate values for sampling the flows during the second time interval. The L4 values may be source port values and/or destination port values in some embodiments.

The first set of flows is limited to a threshold number of flows, in some embodiments. The method may determine that the first set of flows has fewer flows than the threshold number and, based on that identification, provide a new threshold number of flows for the second set of flows, wherein the new threshold number of flows is greater than the threshold number of flows for the first set of flows.

The method of some embodiments further determines that a particular flow to a port in the first logical port window has previously been inspected. Based on that determination, the method excludes the particular flow from the first set of flows. Determining that the particular flow has not previously been inspected may include checking a source port of a packet, of the particular flow, against a set of records of source ports of previously inspected packet flows. Alternately, determining that the particular flow has not previously been inspected may include checking the destination port and destination IP address of a packet, of the particular flow, against a set of records of destination ports and destination IP addresses of previously inspected packet flows.

Sampling a flow may include copying one or more packets in the flow for analysis, extracting information from these packets or extracting information by analyzing these packets. This extraction and/or analysis in some embodiments involves examination of an application layer (e.g., L7 layer) of packets of the flow. In some embodiments, the sample flows are first copied and then the copies are examined to extract information about the flows.

As mentioned above, a sampled logical port window in some embodiments is a set of non-contiguous L4 values that includes several values in a sequence including a first value, a last value and several intermediate values in between, with at least some of the successive values (e.g., intermediate values that follow each other in the sequence of values in the set) not being consecutive values in any numerical range. However, in some embodiments, one or more logical L4 windows (i.e., one or more sets of non-contiguous L4 values) include contiguous buckets of values but two or more buckets of such values are not contiguous with respect to each other. For instance, a first logical window (i.e., a first set of non-contiguous L4 values) may include at least two consecutive port values that are part of one contiguous bucket of values that is followed by value that is not the next port number in a numerical range after the last port number in the bucket. However, in other embodiments, no logical window (i.e., no set of non-contiguous L4 values) includes any consecutive port values.

Each L4 value, in some embodiments, is defined by a binary number, including two sets of binary digits, where each L4 value in the first logical port window has the same set of values for one of the sets of binary digits. The binary number, in some embodiments, has sixteen binary digits, and the final four binary digits of the binary number have the same value within a particular logical port window.

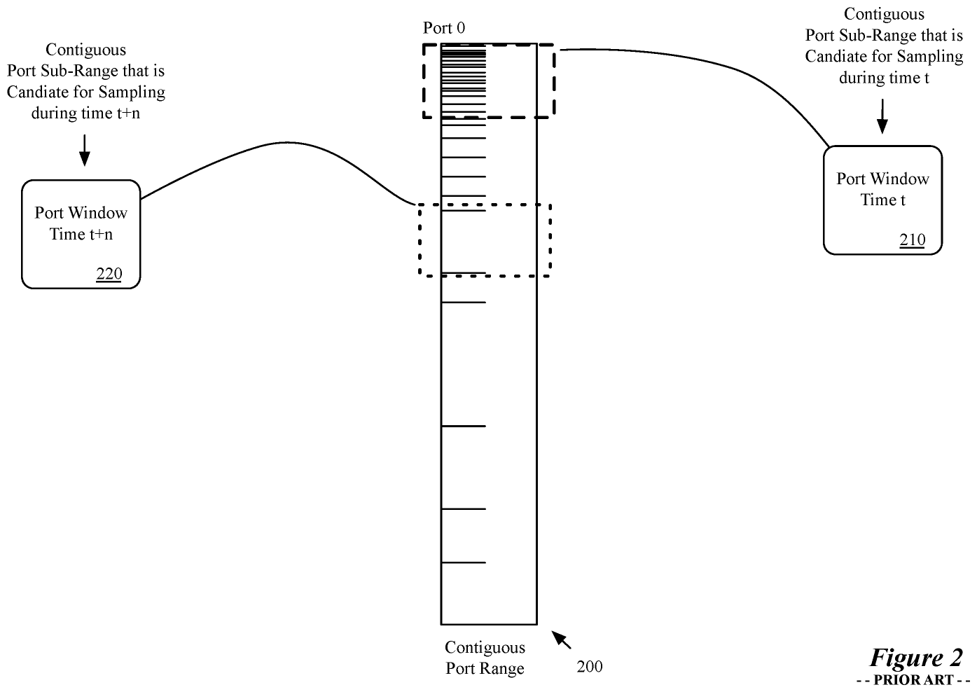

Some prior art flow samplers use windows of contiguous L4 port values to divide the range of possible ports into smaller groups. The prior art flow samplers select flows with port values within a particular window of contiguous port values (e.g., ports 1-1024) for some time period, then select flows with port values within another window of contiguous port values (e.g., ports 1025-2048). A significant problem with port monitoring using windows of contiguous port values sequentially is that some parts of a full range of ports tend to have far more active ports than other parts of the range. Thus a packet sampling system may be saturated while some contiguous windows are monitored, but be underutilized while other contiguous windows are monitored. For example, ports 1-1024 are traditionally heavily used by a variety of network capable applications, while the remaining L4 ports, 1025-65535 are traditionally used by fewer network capable applications. Given such a disparity, the prior art flow sampling methods tend to be unable to report a high percentage of the flows in a window that includes ports 1-1024, but have idle resources when reporting windows of higher port numbers (see, e.g., FIG. 2). Therefore, some embodiments of the present invention generate non-contiguous logical port windows that include multiple buckets of relatively small numbers of ports (or even a single port per bucket), at intervals along the entire port range.

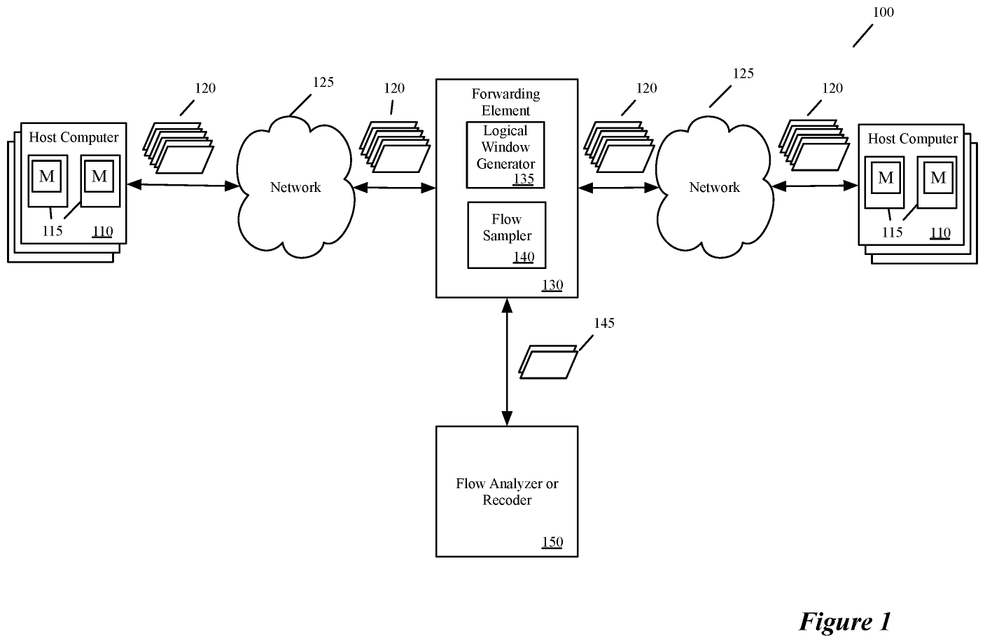

FIG. 1 illustrates a flow sampling system 100 of some embodiments. FIG. 1 includes host computers 110 implementing machines 115 (e.g., virtual machines (VMs), containers, etc.). Applications on the machines 115 send data packets 120 between the machines over networks 125. The packets 120 each include a source address and a destination address. In some embodiments, each address includes an IP address and an associated port number. The port number in some embodiments is an L4 port value. L4 values for ports in decimal form are typically between 0 and 65,535; in hexadecimal form, L4 values for ports are typically between 0000 and FFFF; in binary form, L4 values for ports can be any 16-digit (including leading zeros) binary number. A flow of packets includes all packets with the same source address (IP and port) and destination address (IP and port), and all return packets with the original source and destination addresses reversed. In some cases, packets of a flow going in one direction (typically either packets sent by the machine that originates a flow or packets leaving a network on which the flow sampler operates) may be referred to as “outgoing packets” while packets of the flow in the other direction may be referred to as “incoming packets.”

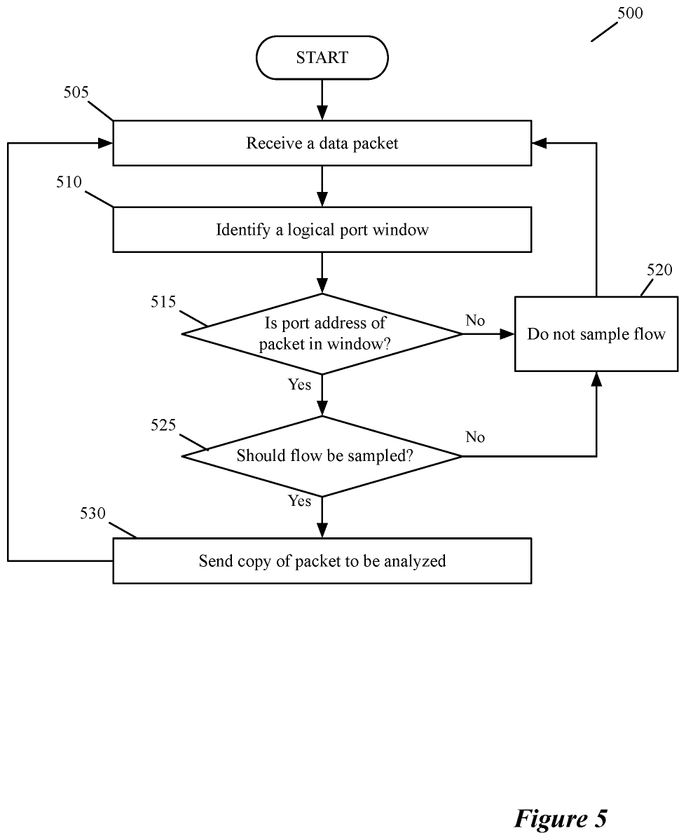

At some location, in the path of the packets 120, through the networks 125, a forwarding element 130 monitors the flows of the packets 120. The forwarding element 130 may be a physical or software forwarding element. The forwarding element 130 includes a logical window generator 135 and a flow sampler 140. The logical window generator 135 defines non-contiguous logical port windows to sample. Each non-contiguous logical port window includes a subset of the possible port numbers of an address of the packets. In some embodiments, the ports are source ports of the original packet flows and, in some embodiments, the ports are destination ports of the original packet flows. The flow sampler 140 copies packets of flows with port numbers in the window defined by the logical window generator 135. However, the flow sampler may not copy packets of all such flows for various reasons described further with respect to FIG. 5. The copied packets are a subset of the packets 120, of FIG. 1, passing through the forwarding element. The flow sampler 140 then sends these copied sample packets 145 to a flow analyzer or recorder 150 where the sample packets 145 can be analyzed. In some embodiments, the flow analyzer 150 includes a deep packet inspector (DPI) that inspects packets at the application layer (e.g., the L7 layer) to identify application parameters such as APPID (identifying type of data in the flow packet payload), source application name (i.e., the name of the source application that sent the packet flow), process identifier (i.e., the name of the process that sent the packet flow), Cipher Suites, URLs, domain name system (DNS) Queries, etc.

The flow analyzer records for each sampled flow the set of L7 attributes identified by the DPI engine (e.g., APPID, Cipher Suites, URLs, domain name system (DNS) Queries, etc.). These records are then transferred to a database, which network administrators query to retrieve information about the type of flows passing through the datacenter's network and/or type of applications (as identified by the extracted L7 attributes such as AppID, application name, etc.) executing on the host computers of the datacenter. Such records are also queried by one or more automated processes in the datacenter to generate reports for network administrators.

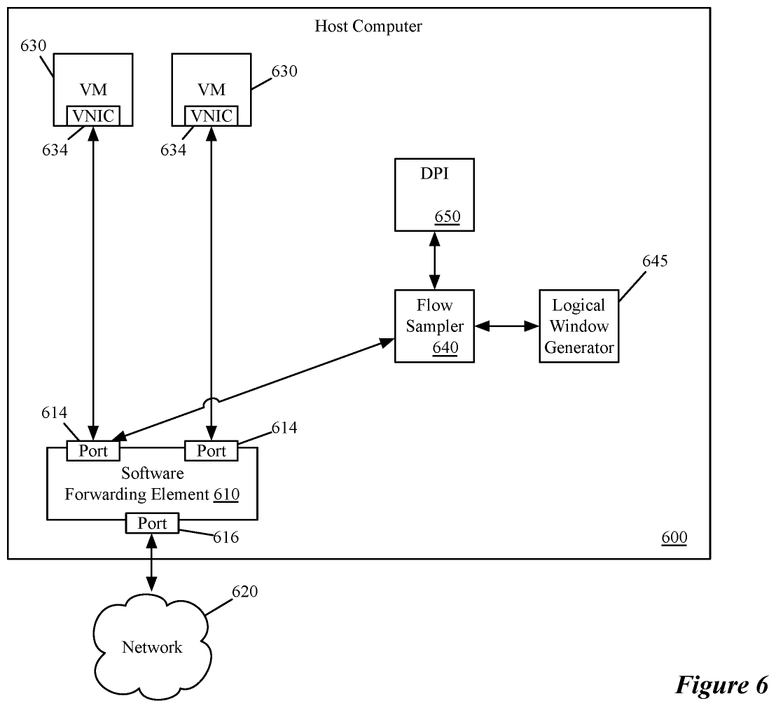

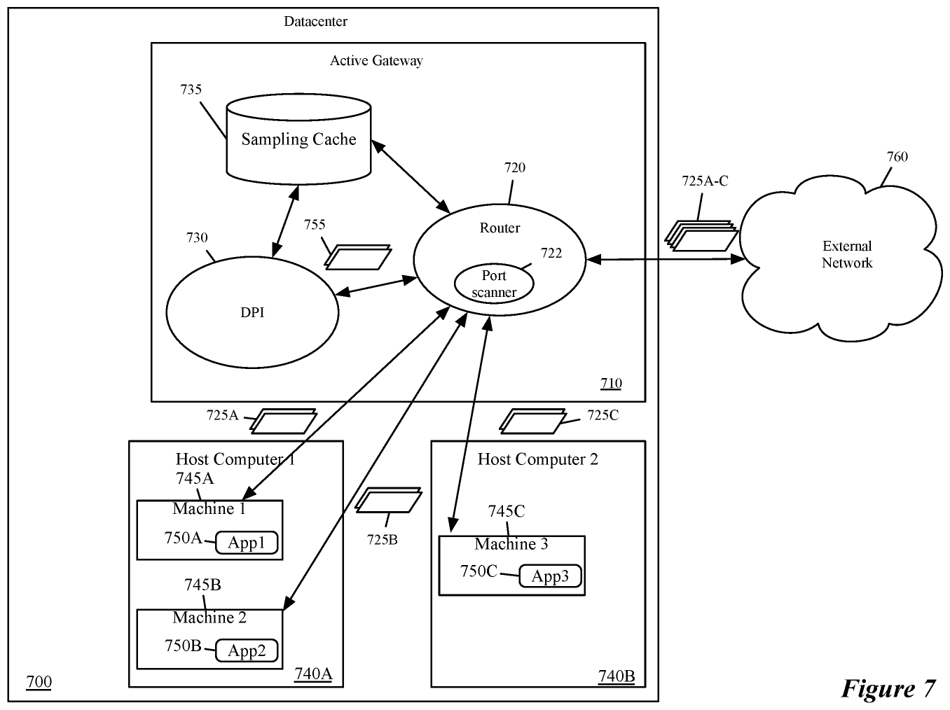

One of ordinary skill in the art will understand that some embodiments operate in networked systems in which both host computers 110 and the forwarding element 130 are in a datacenter at one physical location. Some embodiments operate in networks where one host computer 110 is in a datacenter in one physical location, the other host computer 110 is in a datacenter in a second location, and the forwarding element 130 is in the datacenter of one of the host computers 110. Some embodiments operate in networks where each host computer 110 and the forwarding element 130 are in separate datacenters. FIGS. 6 and 7, below, illustrate different deployment locations for forwarding elements of some embodiments.

Although the embodiments described herein determine their logical port windows based on either source port values or destination port values, one of ordinary skill in the art will understand that some embodiments use additional flow attributes to determine which flows to sample. For example, some embodiments might further divide the logical port windows by what protocol (TCP, UDP, etc.) the packets of a flow are using, what destination IP address range the outgoing packets of flows are sent to, etc. Similarly, some embodiments may define logical windows based on both the source and destination ports of the packets of flows.

As previously mentioned, in a typical network, the port values used by data flows are not evenly distributed. In practice, most flows use port values from 1-1024. In some existing flow sampling systems, flow sampling is broken down into contiguous windows of port value candidates. FIG. 2 conceptually illustrates an example of prior art port window sampling ranges. FIG. 2 includes contiguous port range 200 of packets arriving at forwarding element of a network. Ports in port range 200 that have active flows shown as lines extending half way across the port range 200. Ports with active flows are referred to herein as “active ports.” The active ports in contiguous port range 200 are concentrated in the lower port numbers as is typically the case in the flows of networks. The contiguous port range 200 in this prior art system is divided into windows of contiguous port values for sampling. For clarity, two port windows 210 and 220 are shown. However, one of ordinary skill in the art will understand that the entire contiguous port range 200 may be broken down into a set of contiguous windows of port values.

As mentioned, the active ports in the contiguous port range 200 are concentrated at lower port values. Therefore, the port window 210 includes a majority of the active ports in contiguous port range 200. The port window 220 includes another range of contiguous port values, higher than the port values of port window 210. Because port window 220 includes less commonly used port values, it includes very few active ports. Accordingly, a flow sampler and a flow analyzer in a prior art system would be overwhelmed (able to sample only a small fraction of candidate flows) during a time period in which it sampled flows with port values in port window 210, while having unused capacity during a time period in which it sampled flows with port values in port window 220.

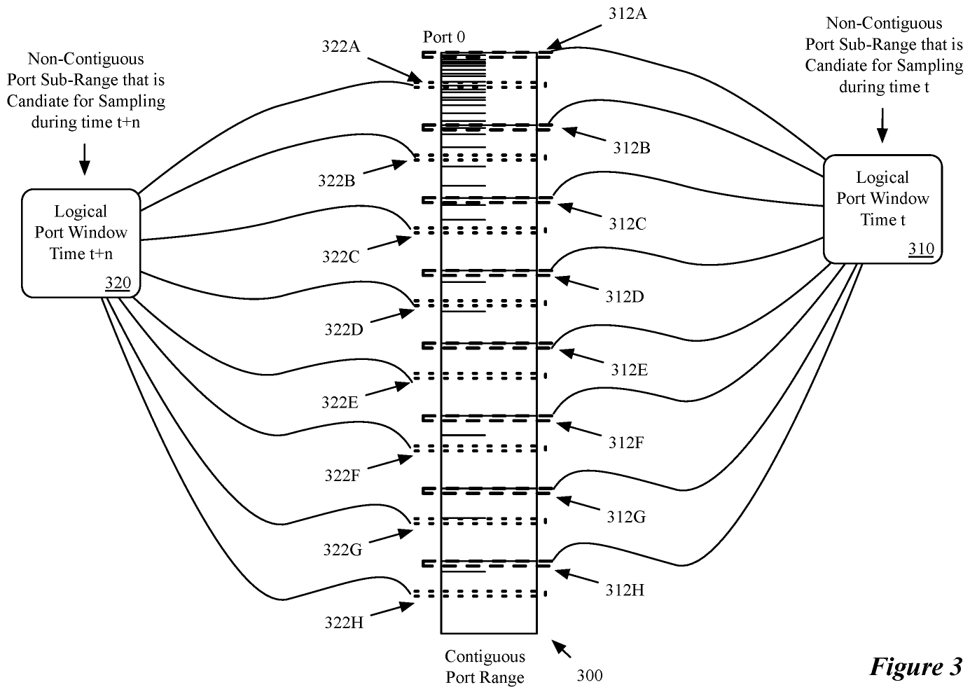

Some embodiments of the present invention provide a system and method using non-contiguous logical port windows to produce a more even distribution (among logical port windows) of candidate flows for sampling. Also, in some embodiments, sampling flows with port values from each non-contiguous window is performed during a particular time in a cycle that allows all ports in a contiguous port range to be candidates for sampling over the course of a full cycle. FIG. 3 conceptually illustrates an example of logical port windows 310 and 320, with non-contiguous port values, used to identify candidates for flow sampling. FIG. 3 includes an example of a contiguous port range 300 with ports that have active flows shown as lines extending half way across the port range 300. Ports with active flows are referred to herein as “active ports.” The active ports in contiguous port range 300 are concentrated in the lower port numbers as is typically the case in networks. FIG. 3 also includes two logical port windows 310 and 320.

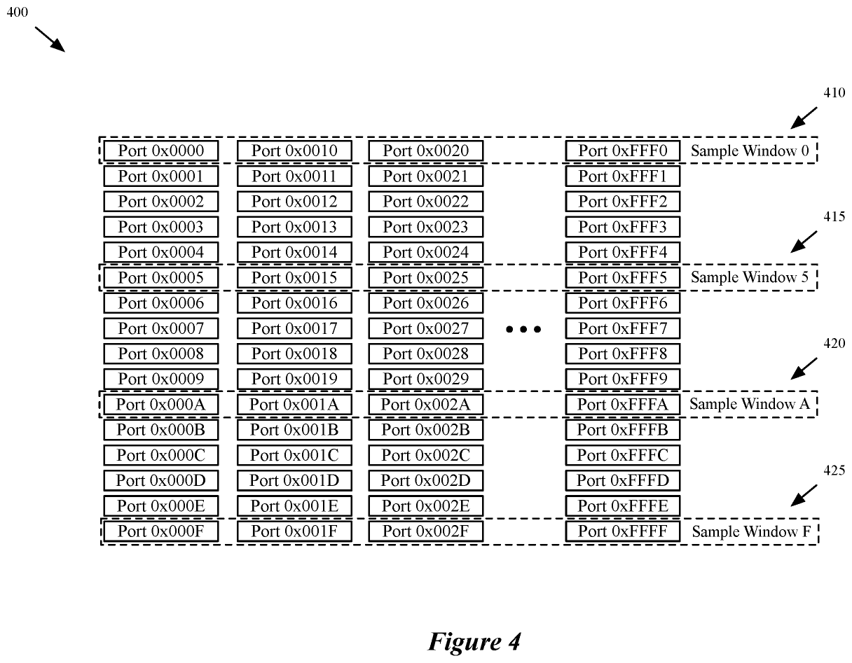

Logical port windows 310 and 320 each includes a non-contiguous set of port values (e.g., L4 port values). Logical port window 310 contains port values in the ranges encompassed by port buckets 312A-312H. In this embodiment, each bucket 312A-312H includes multiple ports that have contiguous values within their bucket 312A-312H, though no port in any bucket has a value adjacent to a value in any other bucket 312A-312H. However, in some embodiments, logical port windows do not include any two ports with adjacent port values (See, e.g., FIG. 4).

Logical port window 310, of FIG. 3, provides one of a set of heuristics that determine whether to sample an incoming packet of a flow. Logical port window 310 identifies port values that are candidates for flow sampling during a time period t. That is, when a packet comes in during a time period t, the flow sampler (e.g., flow sampler 140 of FIG. 1) rejects it for sampling unless the port value of the packet is within the port values designated by the logical port window. One of ordinary skill in the art will understand that in some embodiments, merely having a port value within the current logical port window does not guarantee that a packet of a particular flow will be sampled, but that other heuristics may be applied to determine whether to sample a packet of a flow. Such heuristics are further described with respect to FIG. 5.

In addition to having a logical port window 310 for identifying candidate ports for sampling during time t, FIG. 3 also includes logical port window 320 for identifying candidate ports during time period t+n. Logical port window 320 contains port values in the ranges encompassed by port buckets 322A-322H. Like buckets 312A-312H, each bucket 322A-322H includes multiple ports that have contiguous values within their bucket 322A-322H, though no port in any bucket has a value adjacent to a value in any other bucket 322A-322H.

Because each logical port window 310 and 320 includes multiple small buckets of port values along the entire range of available port values, neither logical window 310 nor 320 includes significantly more active ports of contiguous port range 300 than the other logical window 310 or 320. That is, each logical port window 310 and 320 includes a roughly equal share of the active ports of contiguous port range 300.

In some embodiments, the contiguous port range 300, of FIG. 3, is divided into a set of logical port windows, with each port of the entire contiguous port range 300 represented in at least one of the logical port windows. For clarity, only two logical port windows 310 and 320 are shown, while other logical port windows (not shown) encompass the rest of the port values of the contiguous port range 300. In such embodiments, the flow sampler (e.g., flow sampler 140 of FIG. 1) cycles through the set of logical port windows with each logical port window defining a set of port values that render a packet of a flow a candidate for sampling during a set time period of the cycle. In each time period of the cycle, the flow sampler rejects sampling of flows with port values outside the logical port window associated with that cycle. By cycling through all the logical port windows in a set, the flow sampler makes all ports in the contiguous port range 300 candidates for sampling at some time during the cycle (though other heuristics may prevent a candidate flow from being sampled in a given cycle). The roughly equal shares of active ports in each logical window prevents the flow sampler and/or flow analyzer of some embodiments from becoming swamped during the time periods of some logical port windows and left idle during time periods of other logical port windows.

Different embodiments may define logical port windows with different non-contiguous port sub-ranges. Some embodiments, such as the one illustrated in FIG. 3, include logical port windows with multiple buckets of multiple ports. Within each bucket, the port ranges are contiguous in such embodiments. For example, some embodiments define port windows by setting a particular subset of the digits of the binary number to a fixed value and including all ports with that fixed value for those bits as part of the window.

In one example of a set of logical windows of port values, with each logical window having multiple buckets, a contiguous port range from port 0 to port 65535 (i.e., binary port values from 0b0000-0000-0000-0000 to 0b1111-1111-1111-1111) is divided into 16 logical port windows. Each logical port window is generated by identifying all ports with common values for the 7th-11th bits of a binary representation of the ports. This results in each logical port window of the set including 64 buckets of 64 contiguous ports each. Thus each of the 16 logical port windows includes 4096 port values. The first window includes all ports whose binary representation is in the form 0bXXXX-XX00-00XX-XXXX, where any of the digits marked as “X” may be either 0 or 1. The ports in the first bucket include 64 ports with binary representations 0b0000-0000-0000-0000 (port 0) to 0b0000-0000-0011-1111 (port 63) and so on until the sixty-fourth bucket of the first logical window includes ports with binary representations 0b1111-1100-0000-0000 (port 64512) to 0b1111-1100-0011-1111 (port 64575). Other logical windows in that set would each have a different particular value for the 7^{th}-11^{th} bits (e.g., 0001, 0010, etc.).

Among embodiments that include logical port windows with multiple buckets, each of which includes multiple contiguous port values, some embodiments may use more (or fewer) buckets with more (or fewer) ports per bucket and/or more (or fewer) logical windows in the set that includes all (or at least most) available port values. Alternatively, some embodiments may include logical port windows with no contiguous port values. Such embodiments would have one port value per bucket. FIG. 4 illustrates examples of logical port windows with no contiguous port values. FIG. 4 includes ports 400 and logical port windows 410, 415, 420, and 425. One of ordinary skill in the art will understand that the full set of logical port windows in the illustrated embodiment includes 16 logical port windows, but for clarity only 4 are shown as examples.

Each logical port window in the embodiment of FIG. 4 includes 4096 non-contiguous ports. Each port in a particular logical window is offset from the previous port by 16 port values. Logical port window 410 includes all ports that can be represented with a hexadecimal value ending in 0, e.g., port 0x0000 (port 0), port 0x0010 (port 16), . . . , port 0xFFF0 (port 65,520). Logical port window 415 includes all ports with a hexadecimal value ending in 5, e.g., port 0x0005 (port 5), port 0x0011 (port 21), . . . , port 0xFFF0 (port 65,525). Logical port window 420 includes all ports with a hexadecimal value ending in A, e.g., port 0x000A (port 10), port 0x001A (port 26), . . . , port 0xFFFA (port 65,530). Logical port window 425 includes all ports with a hexadecimal value ending in F, e.g., port 0x000F (port 15), port 0x001F (port 31), . . . , port 0xFFFF (port 65,535).

As in the logical port windows of the previously described example with 16 logical windows of 64 buckets of 64 contiguous port values each, cycling through all 16 logical port windows in the embodiment of FIG. 4 allows flows of any port value to be candidates for flow sampling at some point during the cycle, without any one logical port window including a disproportionate share of the active ports.

FIG. 5 conceptually illustrates a process 500 for sampling flows using a logical port window. In some embodiments, the process 500 is performed by a flow sampler (e.g., flow sampler 140 of FIG. 1). The process 500, of FIG. 5, begins by receiving (at 505) a data packet of a data packet flow. In some embodiments the data packet is a data packet sent from one machine to another over one or more networks. The packet of some embodiments includes an address tuple with at least a source IP address, a source port, a destination IP address, and a destination port.

The process 500 then identifies (at 510) a logical port window. In some embodiments, the logical port window is supplied by a logical window generator (e.g., logical window generator 135 of FIG. 1). The flow sampler periodically receives data identifying the logical port window from (pushed by) the logical window generator, in some embodiments. The received data identifies the logical port window for the flow sampler to use for the time period immediately after the identifying data arrives, in some embodiments. In other embodiments, the flow sampler may access (pull from) the logical window generator to receive data that identifies the current logical port window. In still other embodiments, the logical window generator may supply the flow sampler with a complete set of logical port windows. The flow sampler in such embodiments would store the complete set of logical port windows and apply each logical port window in turn for part of a cycle (e.g., a cycle of multiple time periods). Although not an explicit operation of process 500, of FIG. 5, one of ordinary skill in the art will understand that as operation 500 iterates, time will pass. Accordingly, different logical port windows will be identified in different iterations of the process 500.

The process 500 then determines (at 515) whether a particular port address of the received packet is within the identified logical port window. That is, the process 500 determines whether the port address of the packet has a value that matches one of the port values identified by the logical port window. In some embodiments, operation 515 determines whether the source port of the received packet is within the logical port window. In other embodiments, operation 515 determines whether the destination port of the received packet is within the logical port window. In some embodiments, whether the process 500 compares the source address of the packet or the destination address of the packet to the port values of the identified logical window depends on whether the packet is an incoming or outgoing packet. If the relevant port address of the packet is not within the identified logical port window, then the process 500 does not sample (at 520) the flow to which the packet belongs and returns to perform operation 505 by receiving a new packet.

If the port address is within the identified logical port window, the process 500 determines (at 525) whether the flow to which the packet belongs should be sampled. One of ordinary skill in the art will understand that there may be a set of heuristics applied to the packet in order to determine whether the flow should be sampled.

There are several potential reasons not to sample a flow in some embodiments. Some examples would be that (1) a threshold number of flows on ports of the identified logical port window had already been sampled during that cycle and time period, (2) the particular port value, though within the identified logical port window, was reserved for some type of data that was identified as never needing to be sampled, (3) flows with the source or destination IP address of the packet excluded from flow sampling, (4) the protocol of the packet was excluded from flow sampling, (5) the flow of the packet was randomly excluded, etc.

Another significant reason for the operation 525 to determine that a flow should not be sampled in some embodiments would be if the operation 525 determines that a flow has previously been analyzed. In some embodiments, this determination is based on records of previously analyzed flows, stored in a sampling cache accessible by the flow sampler. In some embodiments, there are sampling caches in each flow direction. For outgoing packets, the process 500 of some embodiments (e.g., in operation 525) looks up the destination port in a sampling cache, and then checks the associated destination IP because outgoing packets to the same destination port may still be going to different destination IP addresses (i.e., be a different flow which coincidentally has the same port value as a previously sampled flow). If during a threshold period, a flow to this outgoing destination port and destination IP had already been sampled and analyzed, and an APPID for the flow was successfully determined, then there would be no reason to analyze more packets of the flow. However, if operation 525 determined that the destination IP differed from the destination IP stored in the cache in association with the outgoing destination port, then the flow would identified as a flow that had not previously been sampled and thus operation 525 would not exclude the flow from being sampled (at least not because the flow had previously been sampled). One of ordinary skill in the art will understand that IP or port addresses of incoming packets may be similarly checked by operation 525 to determine whether the flow had previously been sampled.

If the process 500 determines (at 525) that the flow should not be sampled, the process 500 does not sample (at 520) the flow and returns to operation 505 to receive a new packet. If the process 500 determines (at 525) that the flow should be sampled, the process 500 sends (at 530) a copy of the packet to be analyzed (e.g., by a flow analyzer, DPI, etc.) and returns to operation 505 to receive a new packet.

In some embodiments, while packets of a flow are being analyzed, the forwarding element which the flow sampler is a part of, blocks the packets of the flow from proceeding (e.g., in a firewall designed to block flows until they have been approved). Similarly, in some embodiments, packet flows that have not yet been selected for sampling may be blocked until they are sampled and analyzed. In other embodiments, the forwarding element sends packets of a flow toward their destination while packets of the flow are still being sampled and analyzed.

As briefly mentioned above, in some embodiments, the process 500 may reject flows for sampling because a threshold number of flows from a particular logical port window has already been inspected within the time period allotted to that logical port window (in a given cycle). This threshold value in some embodiments is a fraction of the total deep packet inspection capacity of the flow analyzer or recorder. The fraction in some embodiments is proportionate to how large a portion of the total port range is represented in the logical port window. For example, if there are 16, equal sized logical port windows covering the entire range of port values, and there is an overall rate limit (R) of how many flows can be inspected in a full cycle of a set of logical port windows, then the threshold for the number of flows to sample in a particular window would be:

R/16 (eq.1)

In some embodiments, when a threshold number of flows for a particular logical port window is not sampled, the process 500 (e.g., as part of operation 525) increases the threshold number for the next logical port window to include the unused number of flows from the particular window.

In some embodiments, the selection of non-contiguous logical port windows is performed by software forwarding elements operating on host computers. FIG. 6 illustrates a host computer 600 implementing a flow sampler 640 that samples packet flows using non-contiguous logical port windows. The host computer 600 also implements a software forwarding element 610, VMs 630, logical window generator 645, and a DPI 650.

The VMs 630 include virtual network interface cards (VNICs) 634. The VNICs 634 allow the VMs 630 and applications running on the VMs 630 to communicate with ports 614 of the software forwarding element 610. The software forwarding element 610 passes packets out through a port 616 to a network 620 (e.g., a network of a datacenter in which the host computer is located). The port 614 communicates directly with the flow sampler 640 and provides the flow sampler 640 with packet data and packets for sampling. The logical window generator 645 defines a set of non-contiguous windows (e.g., as illustrated in FIGS. 3 and 4) of ports to sample. The flow sampler 640 identifies and evaluates packets with a port value (e.g., the port value of the source port or destination port) within the set of port values of the non-contiguous logical port window in use when the packet arrives. If the flow to which an evaluated packet belongs is selected for sampling, the flow sampler 640 passes a copy of the packet to the DPI 650 for analysis.

Although in the embodiment illustrated in FIG. 6, the flow sampler 640 communicates directly with the port 614, in other embodiments, the flow sampler communicates with the port through one or more hardware or software intermediaries. For example, in some embodiments, a distributed firewall (DFW) acts as an intermediary between the flow sampler 640 and the port 614. Although the flow sampler 640 in FIG. 6 is on the same host computer as the VMs 630 sending and receiving the packets, in other embodiments the flow sampler may run on a separate VM of the host, or on a different computer.

Although the previously illustrated embodiments show the flow sampler and logical window generator as separate entities, in some embodiments, the functions described for these entities may be performed by more or fewer elements. Furthermore, the functions of the flow sampler and logical window generator can be performed on other devices than a host computer. For example, in some embodiments, the operations of the flow sampler and logical window generator are performed by a port scanner on an active gateway of a datacenter.

FIG. 7 illustrates a datacenter 700 with a port scanner 722 of some embodiments. FIG. 7 includes a router 720 with a port scanner 722, a deep packet inspector (DPI) 730, a sampling cache 735, host computers 740A and 740B, and external network 760. The router 720 routes packets flows 725A-725C between host computers 740A-740B and external network 760. The packet flows 725A-725C are produced on (or sent to) machines 745A-745C by/to apps 750A-750C.

In the embodiment of FIG. 7, the port scanner 722 itself generates a set of non-contiguous logical windows and applies each window, in turn, for a time period in a multi-time period cycle. The port scanner 722 determines which flows to sample based, at least partly, on whether a port value of the flow is within a non-contiguous logical window that is used for the time period in which a packet of the flow arrives. When the port scanner determines that a packet flow should be inspected, the router 720 sends copies 755 of packets of that packet flow to deep packet inspector 730, which stores the results of the packet inspections in the sampling cache 735 for use by the port scanner to eliminate redundant scans of packet flows.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

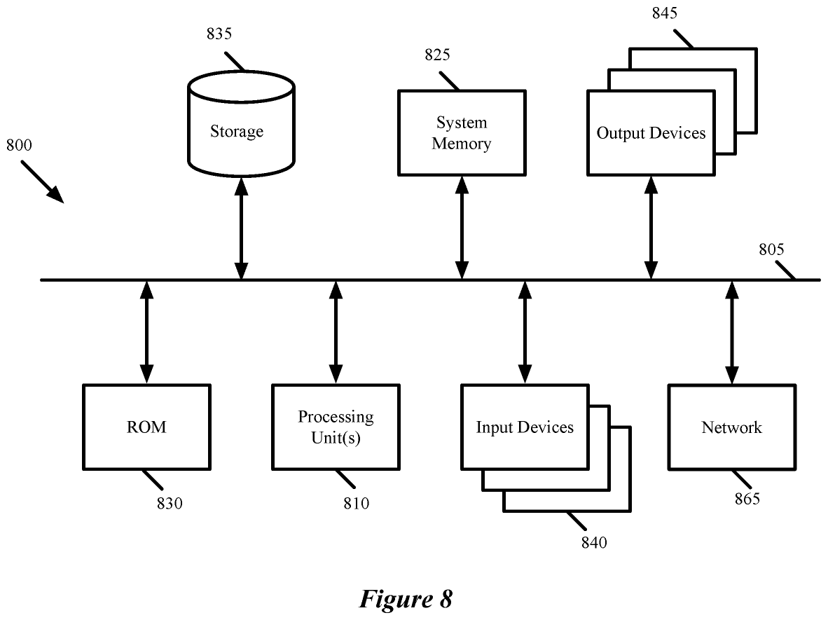

FIG. 8 conceptually illustrates a computer system 800 with which some embodiments of the invention are implemented. The computer system 800 can be used to implement any of the above-described hosts, controllers, gateway and edge forwarding elements. As such, it can be used to execute any of the above-described processes. This computer system 800 includes various types of non-transitory machine-readable media and interfaces for various other types of machine-readable media. Computer system 800 includes a bus 805, processing unit(s) 810, a system memory 825, a read-only memory 830, a permanent storage device 835, input devices 840, and output devices 845.

The bus 805 collectively represents all system, peripheral, and chipset buses that communicatively connect the numerous internal devices of the computer system 800. For instance, the bus 805 communicatively connects the processing unit(s) 810 with the read-only memory 830, the system memory 825, and the permanent storage device 835.

From these various memory units, the processing unit(s) 810 retrieve instructions to execute and data to process in order to execute the processes of the invention. The processing unit(s) may be a single processor or a multi-core processor in different embodiments. The read-only-memory (ROM) 830 stores static data and instructions that are needed by the processing unit(s) 810 and other modules of the computer system. The permanent storage device 835, on the other hand, is a read-and-write memory device. This device is a non-volatile memory unit that stores instructions and data even when the computer system 800 is off. Some embodiments of the invention use a mass-storage device (such as a magnetic or optical disk and its corresponding disk drive) as the permanent storage device 835.

Other embodiments use a removable storage device (such as a floppy disk, flash drive, etc.) as the permanent storage device 835. Like the permanent storage device 835, the system memory 825 is a read-and-write memory device. However, unlike storage device 835, the system memory 825 is a volatile read-and-write memory, such as random access memory. The system memory 825 stores some of the instructions and data that the processor needs at runtime. In some embodiments, the invention's processes are stored in the system memory 825, the permanent storage device 835, and/or the read-only memory 830. From these various memory units, the processing unit(s) 810 retrieve instructions to execute and data to process in order to execute the processes of some embodiments.

The bus 805 also connects to the input and output devices 840 and 845. The input devices 840 enable the user to communicate information and select commands to the computer system 800. The input devices 840 include alphanumeric keyboards and pointing devices (also called “cursor control devices”). The output devices 845 display images generated by the computer system 800. The output devices 845 include printers and display devices, such as cathode ray tubes (CRT) or liquid crystal displays (LCD). Some embodiments include devices such as touchscreens that function as both input and output devices 840 and 845.

Finally, as shown in FIG. 8, bus 805 also couples computer system 800 to a network 865 through a network adapter (not shown). In this manner, the computer 800 can be a part of a network of computers (such as a local area network (“LAN”), a wide area network (“WAN”), or an Intranet), or a network of networks (such as the Internet). Any or all components of computer system 800 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessors or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. For instance, several of the above-described embodiments are described as being deployed on one or more datacenters. Datacenters may be public or private. Additionally, some embodiments may involve elements that are not deployed in a datacenter, such as an individual network capable device in a private home, etc. Similarly, where the above described embodiments describe sampling packet flows between applications running on machines implemented by host computers, other embodiments may include packet flows between physical devices including computers and/or other network capable devices. Thus, one of ordinary skill in the art would understand that the invention is not to be limited by the foregoing illustrative details, but rather is to be defined by the appended claims.

1. A method of sampling data flows, the method comprising:
sampling a first plurality of flows during a first time interval using a first logical port window for the first time interval, the first logical port window identifying a first plurality of non-contiguous layer 4 (L4) values in an L4 port range that are candidate values for sampling the flows during the first time interval; and
sampling a second plurality of flows during a second time interval using a second logical port window for the second time interval, the second logical port window identifying a second plurality of non-contiguous L4 values in an L4 port range that are candidate values for sampling the flows during the second time interval.

2. The method of claim 1, wherein the L4 values are source port values.

3. The method of claim 1, wherein the L4 values are destination port values.

4. The method of claim 1, wherein the first plurality of flows is limited to a threshold number of flows.

5. The method of claim 4, wherein the threshold number of flows is a first threshold number of flows, the method further comprising:
determining that the first plurality of flows has fewer flows than the first threshold number; and
based on that identification, providing a second threshold number of flows for the second plurality of flows, wherein the second threshold number of flows is larger than the first threshold number of flows.

6. The method of claim 1 further comprising:
determining that a particular flow to a port in the first logical port window has previously been inspected; and
based on the determination, excluding the particular flow from the first plurality of flows.

7. The method of claim 6, wherein determining that the particular flow has not previously been inspected comprises checking a source port of a packet of the particular flow against a set of records of source ports of previously inspected packet flows.

8. The method of claim 6, wherein determining that the particular flow has not previously been inspected comprises checking the destination port and destination IP address of a packet of the particular flow against a set of records of destination ports and destination IP addresses of previously inspected packet flows.

9. The method of claim 1, wherein sampling a flow comprises inspecting an application layer of copies of a set of packets of the flow.

10. The method of claim 1, wherein sampling a flow comprises inspecting a layer 7 (L7) of copies of a set of packets of the flow.

11. The method of claim 1, wherein the first plurality of non-contiguous L4 values comprises at least two consecutive port values.

12. The method of claim 1, wherein the first plurality of non-contiguous L4 values does not comprise any consecutive port values.

13. The method of claim 1, wherein each L4 value is defined by a binary number comprising a first set of binary digits and a second set of binary digits, wherein each L4 value in the first logical port window has the same set of values for the second set of binary digits.

14. The method of claim 13, wherein the binary number has sixteen binary digits and the second set of binary digits comprises a final four binary digits of the binary number.

15. A non-transitory machine readable medium storing a program for of sampling data flows, the program for execution by at least one processing unit, the program comprising sets of instructions for:
sampling a first plurality of flows during a first time interval using a first logical port window for the first time interval, the first logical port window identifying a first plurality of non-contiguous layer 4 (L4) values in an L4 port range that are candidate values for sampling the flows during the first time interval; and
sampling a second plurality of flows during a second time interval using a second logical port window for the second time interval, the second logical port window identifying a second plurality of non-contiguous L4 values in an L4 port range that are candidate values for sampling the flows during the second time interval.

16. The non-transitory machine readable medium of claim 15, wherein the L4 values are source port values.

17. The non-transitory machine readable medium of claim 15, wherein the L4 values are destination port values.

18. The non-transitory machine readable medium of claim 15, wherein the first plurality of flows is limited to a threshold number of flows.

19. The non-transitory machine readable medium of claim 18, wherein the threshold number of flows is a first threshold number of flows, the program further comprising sets of instructions for:
determining that the first plurality of flows has fewer flows than the first threshold number; and
based on that identification, providing a second threshold number of flows for the second plurality of flows, wherein the second threshold number of flows is larger than the first threshold number of flows.

20. The non-transitory machine readable medium of claim 15, the program further comprising sets of instructions for:
determining that a particular flow to a port in the first logical port window has previously been inspected; and
based on the determination, excluding the particular flow from the first plurality of flows.
